(19) United States
(12) Patent Application Publication
(10) Pub. No.: US 2016/0202706 A1
(43) Pub. Date: Jul. 14, 2016

(54) DIGITALIZATION OF ANALOG MFC CONTROL INPUT

(71) Applicant: MKS Instruments, Inc,, Andover, MA (US)

(72) Inventors: Michael L'Bassi, Sterling, MA (US); David D'Entremont, Stoneham, MA (US); Zhifeng Liu, Carlisle, MA (US)

(21) Appl. No.: 14/596,737

(22) Filed: Jan. 14, 2015

(51) Int. Cl. G05D 7/06; G05B 15/02

(52) U.S. Cl. CPC G05D 7/06; G05B 15/02

(57) ABSTRACT

A mass flow controller and method are described. The mass flow controller comprises: an analog signal input configured to receive an analog set point signal; a converter configured to convert the analog set point signal to a digital set point signal; and a source of at least one exact non-changing digital set point signal precisely representing a desired rate of flow; wherein the source provides the exact non-changing digital set point signal in response to the digital set point signal so long as the digital set point signal is within a preselected band defining a range of values.

As used herein, the term “gas” is used to an a gas or vapor should the latter two terms be considered different.

In operation, an analog input mass flow controller (“MFC”) operates to maintain the flow rate of gas through the controller as a function of an analog control signal that represents the desired setting (“set point”) of the flow rate through the MFC. The MFC generates a valve control signal for controlling the position of a control valve correlated to the desired set point flow taking into account various sources of error. In general, the analog input MFC typically includes a feedback control that generates the valve control signal as a function of the set point derived from the analog control signal and a signal representing the actual flow rate as sensed by a sensor arrangement of the MFC. MFCs are often employed in high electrically noisy environments. For example, process tools employing RF power supplies and/or poor cabling connections can result in analog signal offsets as well as high environmental noise conditions affecting the analog control signal input of the MFC resulting in errors in the valve control signal, and thus in the controlled flow rate.

While new MFCs have been created that are digital input devices, many existing MFCs are analog input devices. With an increase in need for extremely accurate control of gas flow rates in a number of different processes, it is desirable to still be able to use these devices, without physically modifying them, to accurately control mass flow rates even in high electrically noise environments in order to defer their obsolescence.

### SUMMARY

Certain embodiments disclosed herein relate to amass flow controller comprising: an analog signal input configured to receive an analog set point signal; a converter configured to convert the analog set point signal to a digital set point signal; and a source of at least one exact non-changing digital set point signal precisely representing a desired rate of flow; wherein the source provides the exact non-changing digital set point signal in response to the digital set point signal so long as the digital set point signal is within a preselected band defining a range of values.

In one embodiment the source is configured to provide the exact non-changing digital set point signal in response to the digital set point signal within the preselected band for a predetermined amount of time.

In one embodiment the level of the exact non-changing digital set point signal, the preselected band of the digital set point signal and the predetermined amount of time are user preselected.

In one embodiment the source is configured to provide any one of a plurality of different exact non-changing digital set point signals, each exact non-changing digital set point signal being provided in response to a corresponding digital set point signal so long as the digital set point signal is within a respective preselected band defining a range of values associated with the that digital set point signal.

In one embodiment the mass flow controller further including a sensor arrangement configured to provide data representing the actual rate of flow of gas through the mass flow controller, a control valve responsive to a valve control signal configured to control the flow of gas through the mass flow controller, and a control unit for generating a valve control signal as a function of a selected exact non-changing digital set point and the data representing actual rate of flow of gas through the mass flow controller.

In one embodiment the sensor arrangement is thermal-based.

In one embodiment the sensor arrangement is pressure-based.

In one embodiment the valve control signal is a voltage predetermined as a function of the control valve and correlated to a valve position that provides a flow rate though the mass flow controller substantially equal to the selected set point.

In one embodiment the mass flow controller further includes a sensor arrangement configured to provide data representing the actual rate of flow of gas through the mass flow controller, and a control valve responsive to a valve control signal configured to control the flow of gas through the mass flow controller, wherein the source includes a processor configured to generate the valve control signal as a function of the exact non-changing digital set point and data representing the actual rate of flow of gas through the mass flow controller.

In one embodiment the valve control signal is a voltage predetermined as a function of the control valve and correlated to a valve position that provides a flow rate though the mass flow controller substantially equal to the set point.

In one embodiment the source is configured to provide anyone of a plurality of different exact non-changing digital set point signals depending on the digital set point signal converted by the converter.

In one embodiment the mass flow controller further includes enabling/disabling arrangement configured to the allow the mass flow controller to operate in at least two modes of operation, the first mode of operation wherein the mass flow rate is a function of the exact non-changing digital set point signal, and a second mode of operation wherein the mass flow rate is a function of the digital set point signal converted by the converter.

Certain embodiments disclosed herein relate to a method of providing at least one predetermined fixed valve control signal representing a desired flow rate through a control valve of a mass flow controller, in response to an analog set point signal, independent of noise in the analog set point signal, the method comprising: receiving the analog set point signal at an analog signal input; converting the analog set point signal to a digital set point signal; and providing the exact non-changing digital set point signal in response to the digital set point signal so long as the digital set point signal is within a preselected band defining a range of values.

### BRIEF DESCRIPTION OF THE DRAWINGS

FIG. 1 shows a high level block diagram of a typical analog input MFC for controlling the flow rate of a gas to a process tool;

FIG. 2 graphically illustrates a typical set point signal converted to a digital signal for use in an analog MFC showing quantization noise contained in the set point signal in the absence of compensation according to the teachings of the present disclosure;

FIG. 3 is a screen shot of one embodiment of a graphical user interface showing the shelving function (enabled) and setting the parameters of each shelving setting in accordance with the teachings of the present disclosure;

FIG. 4 is a screen shot of one embodiment of a graphical user interface showing the shelving function disabled;

FIG. 5 is an exemplary graphical representation showing the analog and corresponding digital control signals when the shelving function is disabled and then enabled at a certain point of time;

FIG. 6 is a flow diagram of the operation of the system of FIG. 1 using the teachings of the present disclosure; and

FIG. 7 is a graphical illustration of an example of a shelving function enabled set point transition response.

### DETAILED DESCRIPTION OF THE DRAWINGS

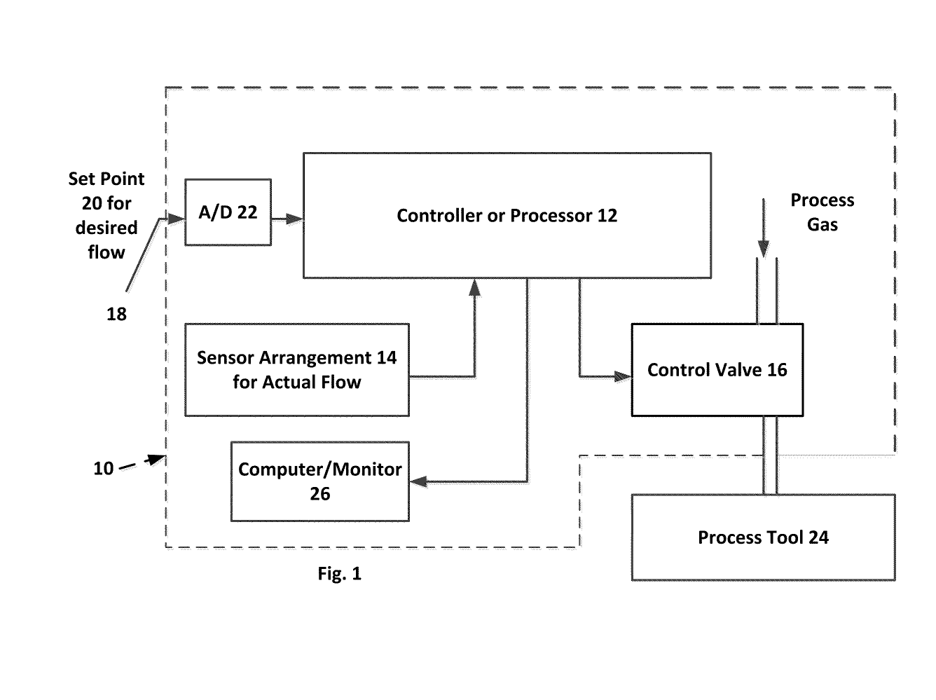

Referring to FIG. 1, a typical analog input MFC 10 includes a controller or processor 12 (for convenience of exposition herein referred to as a “processor”), a sensor arrangement 14 for sensing the actual flow through the MFC 12, and control valve 16 responsive to the set point flow rate setting and the sensed actual flow in order to control the actual flow rate so that it is equal to the set point flow rate. An analog input 18 to the MFC receives an analog set point flow rate signal 20 representing the desired set point position of the control valve corresponding to the set point flow rate. The analog signal at input 18 is converted to a digital signal by the analog to digital (A/D) converter 22. The digital signal output of A/D converter 22 is applied to a control input of processor 12. In operation, the processor 12 is configured to use feedback control in response to the set point input and the sensed flow from the sensor arrangement 14 to control the position of the valve 16 so that the flow from the valve to, for example, process tool 24 is maintained at the set point level. A computer and monitor 26 are typically used to provide a recipe defining the steps that the MFC uses to complete the steps of the recipe to be performed, for example, by the process tool 24. Thus, the rate of flow of one or more gases provided from one or more sources (not shown) delivered to the process tool 24 can be selectively controlled by the MFC 10. During a process carried out by process tool 24, the set point may reset during the process any number of times causing the position of the control valve to adjust with each new setting.

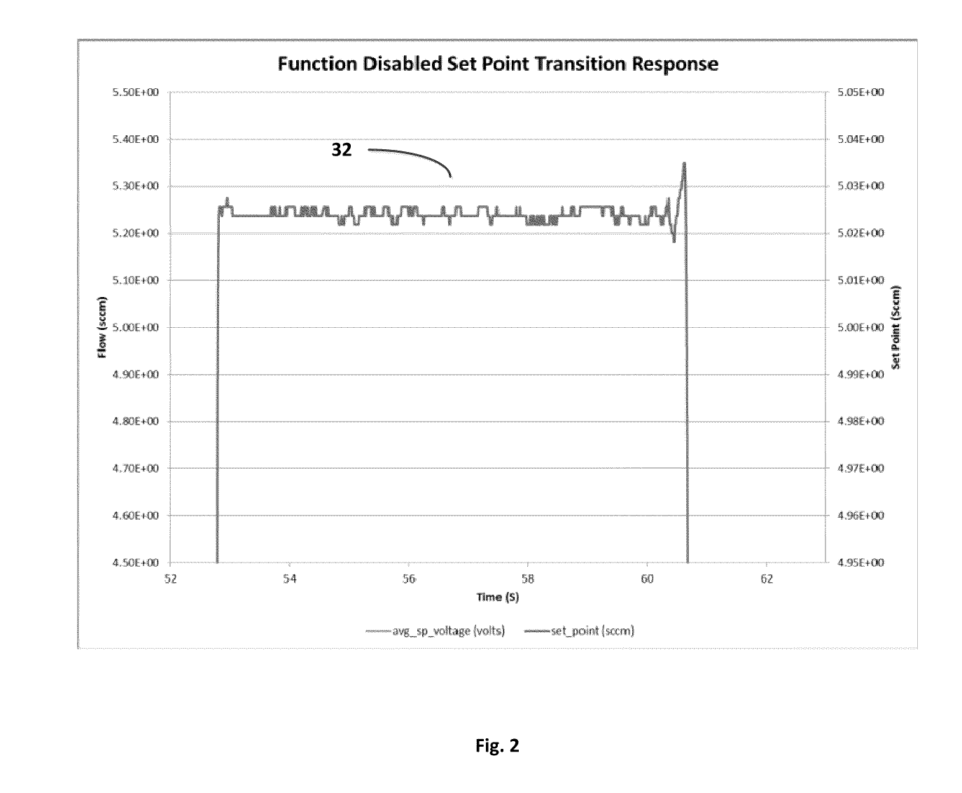

In process tool environments, the analog set point signal 20 can be very noisy. The result is that the digital signal provided by the A/D converter 22 can contain quantization noise, such as shown at 32 in FIG. 2, which passes through the control system of the MFC 10. Thus, during and following each set point transition, the MFC controls the position of the control valve subject to the quantization noise. This can result in control errors and fluctuations in the gas flow rate.

In accordance with the teachings described herein, the analog input MFC can be modified, by further configuring the processor 12 to include a “shelving” function, without having to physically change the MFC configuration or the process tool. The function is designed to substantially reduce if not eliminate the effect of set point signal noise on the control operation of the MFC. The processor configured with a shelving function defines a source of at least one exact non-changing digital set point signal precisely representing a desired rate of flow. The processor functions as a source providing the exact non-changing digital set point signal in response to the digital set point signal so long as the digital set point signal is within a preselected band defining a range of values.

The shelving function includes a feature in which for each exact non-changing desired set point, a fixed valve control signal is provided to the valve so long as the digital set point signal provided by the A/D converter is within a within a preselected band defining a range of values. Providing a fixed control signal in this manner eliminates any effects of the quantization noise, wherein the predetermined range of values for each exact non-changing desired set point signal includes the anticipated noise imposed on the digital set point signal. A separate predetermined range of values can be applied to each exact non-changing desired set point for a particular recipe.

The function can be enabled or disabled and the various parameter values set through, for example, a web browser provided on the computer and monitor 26. The user can also choose one or more target flow rates and thus the corresponding valve control signals (the respective valve settings) corresponding to the exact non-changing desired set point signals depending on the recipe to be provided to process tool. Thus, for a particular target set point (referred to herein as the “shelving points”), the specific exact non-changing desired set point signal, typically corresponding to a valve control voltage, is known; and it is desirable to apply this voltage to the control valve when setting the flow to the specific target set point. By setting a range of values of the band of digital set point signals that will result in the same exact non-changing desired set point signal, and providing the corresponding specific valve control signal when the digital set point signal is within that band, the effect of the noise contained in the digital set point signal is eliminated. For example, if the shelving point for a flow rate of 500 sccm is set at a fixed 500 millivolts, and the band of the set point ranges from the 500 millivolts ±50 millivolts, then the MFC will provide a valve control voltage equal to the 500 millivolts regardless of the digital set point value received so long as it is within the range defined by the user. Note that while the band is defined with a center fixed value of 500 millivolts, it is possible that the fixed value is different from the center value of the range or band so long as the digital set point value lies within the range defined by the band. It should be appreciated that the MFC can be configured to provide a plurality of different user-defined fixed shelving point values, each with its own user-defined range or band.

In addition, in one embodiment, a settling time can be user-defined in which a time window for the input voltage band is defined, wherein the voltage set point to the MFC must be within the settling band for the duration of time of the settling time variable before the fixed valve control signal is provided. The target flow is assigned to a specific set point voltage a settling band window. Finally, in one embodiment the fixed valve control voltage can be calculated based on a flow value, and populated in a display (for example a browser page) once the flow value is selected.

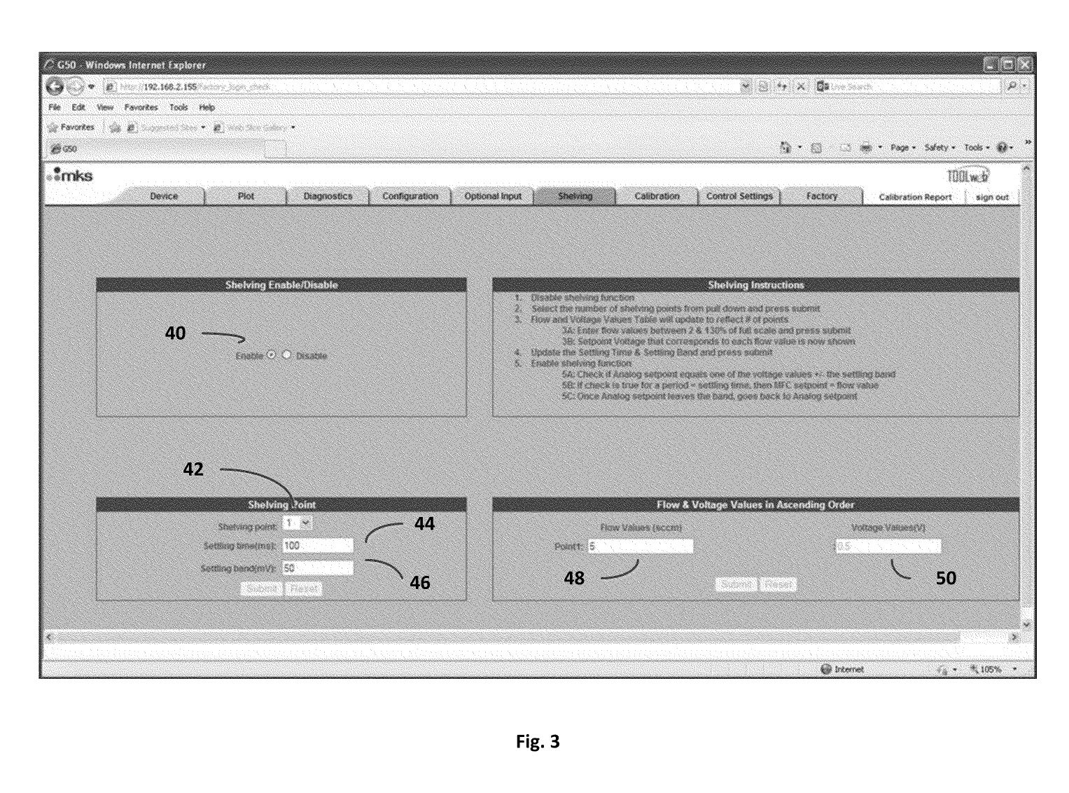

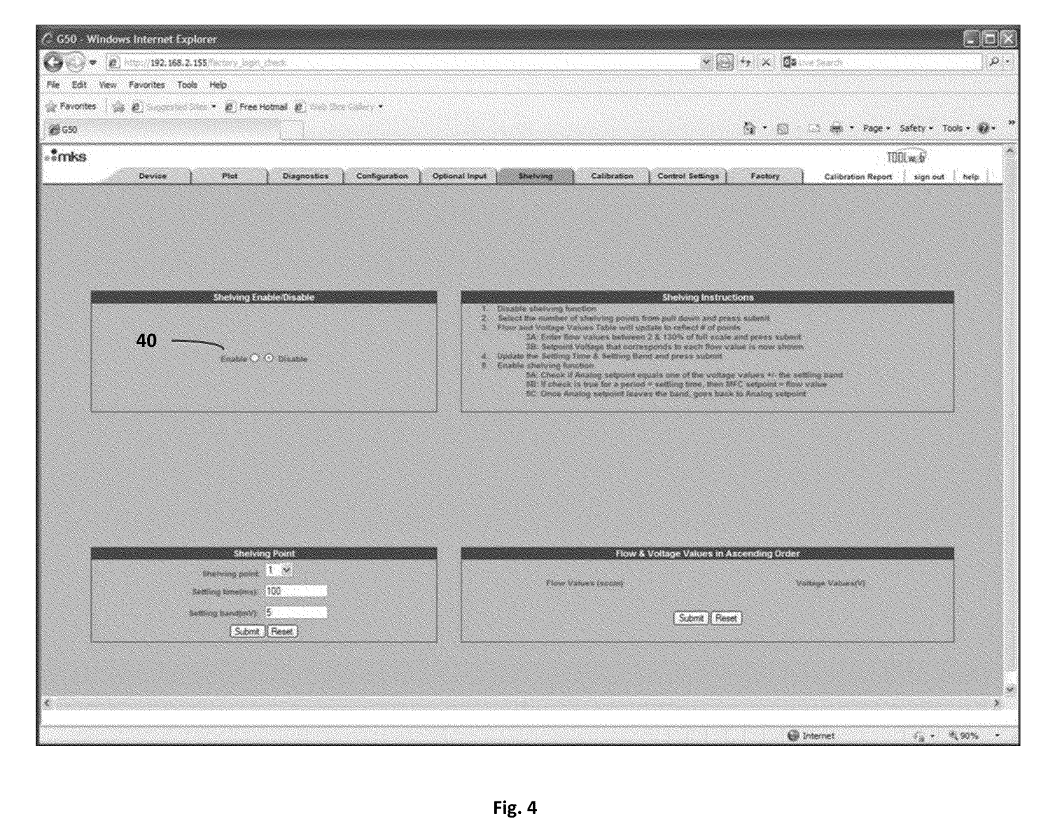

Referring to FIGS. 3 and 4, an example of screen shots of a graphical user interface for the computer monitor of the computer/monitor 24 of FIG. 1, including exemplary fields for entering information in order to set the various variables for the shelving function. The screen shots are illustrated as browser pages, although each page can be based on other program applications, and take on different graphical user interface views. One field 40 allows the user to enable or disable the shelving function, with the shelving function being shown enabled in FIG. 3, and disabled in FIG. 4. Prior to running a process with the shelving function enabled, the number of shelving points are determined from the process to be run, e.g. how many different target values are needed. For each shelving point (for example, consecutively numbered starting with 1) identified in the field 42 (shown as a pull down), the relevant variables for the corresponding shelving point are defined based on the desired performance. The flow values for the corresponding shelving points are entered, for example, in ascending order in field 44 (starting with the lowest flow rate and ending with the highest flow rate, e.g., between 2% and 130% of full scale). Following the entry of the flow range, the respective set point signal that corresponds to the valve control signal (e.g., in volts) is shown in field 46. In one embodiment, the latter values are predetermined based on the control valve used, and provided to the processor 12 prior to the user providing the parameters, so that the values can be automatically generated in the field 46. Once generated, the settling time and settling band for each settling point can then be updated in fields 48 and 50, respectively, based upon desired performance. The set parameters can then be submitted and stored in memory of the processor 12, for example, as a shelving matrix. The shelving function can be enabled at field 40. If desired by the user, the analog set point can be checked to be sure it equals one of the voltage values within the corresponding settling band. In operation, once the analog set point signal triggers the set point shelving value, it will remain at the set point shelving value so long as the analog set point signal remains within the settling band. When the analog set point moves outside the predetermined band, the MFC will revert back to being responsive to the analog set point, until such time as the analog set point enters a band for the same or another shelving set point. Note that when in the disabled mode as shown in field 40 in FIG. 4, some of the fields are disabled.

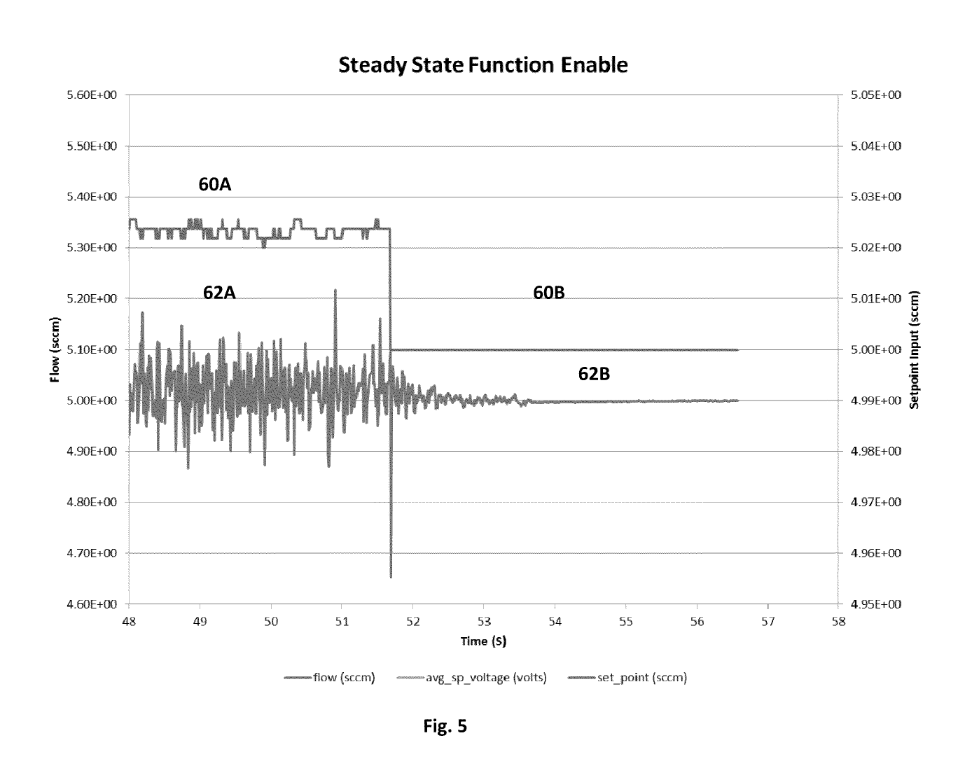

Referring to the graphical illustration of FIG. 5, an exemplary representation of the digital set point valve and the corresponding flow of an MFC is shown first with the shelving function disabled, and then enabled in order to illustrate the advantages of the shelving function feature. More specifically, the left side of the graph shows the operation of the MFC with the shelving function disabled. As seen the digital set point signal shown at 60A contains quantization noise. As a result the flow 62A responds with undesirable variations that can significantly degrade the operation by the process tool. When the shelving function is enabled, as indicated in the right side of the graph, it can be seen that the set point signal at 60B is set at the shelving point voltage void of noise, with a settling of the flow settling to a nearly constant value at 62B.

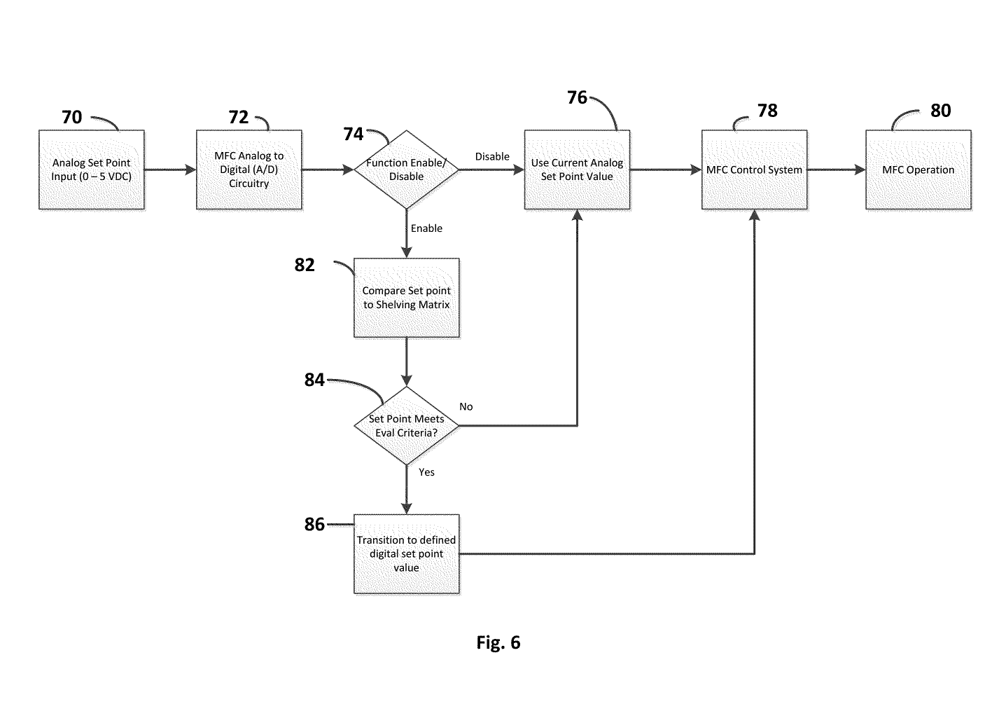

In one embodiment, the processor 12 is further configured to carry out the steps outlined in the flow chart of FIG. 6. As shown at 70, the analog set point input signal is applied to the A/D converter, which in turn (at 72) generates a digital signal representing the analog set point input signal. At 74, a determination is made whether the shelving function is enabled or disabled. If disabled, the MFC uses the current analog set point value as indicated 76, and applies that value to the MFC control system at 78. The controls then provide at 80 the corresponding control voltage to the control valve of the MFC based on the current analog set point value and the flow sensed by the sensor arrangement of the MFC.

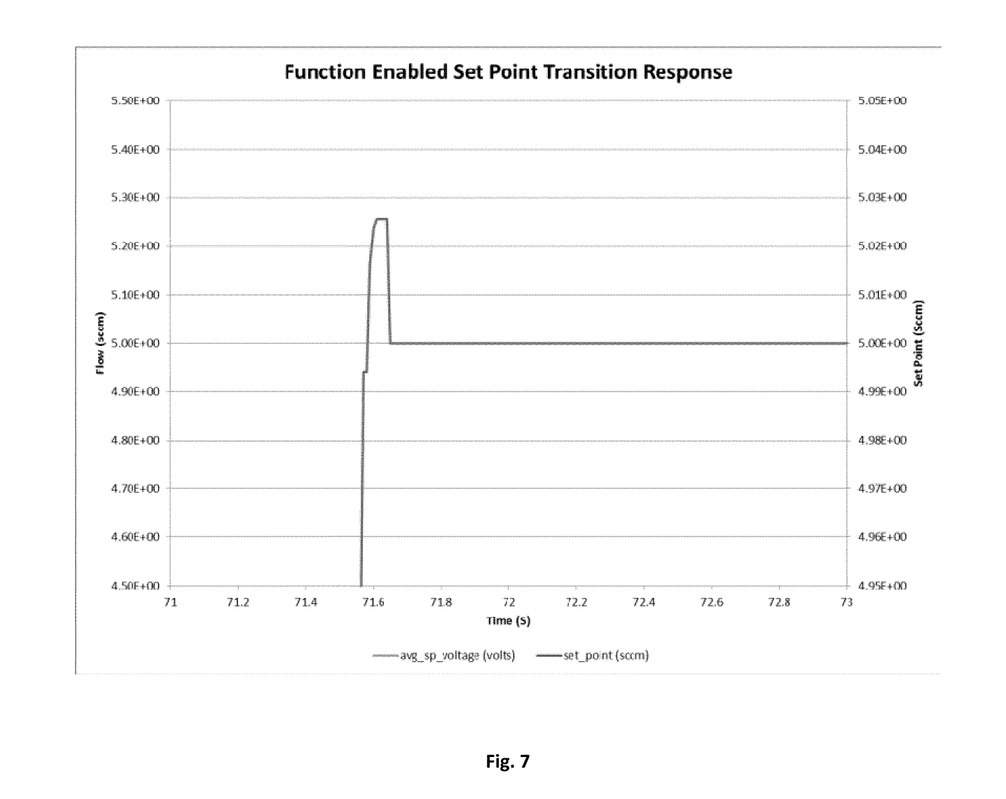

If a determination is made at 74 that the shelving function is enabled, the analog set point is compared at 82 with the values in the values in the shelving matrix. A determination is made at 84 whether the set point meets the evaluation criteria. If no, the MFC proceeds to use the current analog set point value and step 76, and proceeds through steps 78 and 80. If at step 84 a determination is made that the set point meets the evaluation criteria of one of the shelving set point values, the MFC transitions at step 86 to the defined digital set point, and then applies that defined digital set point value to the MFC control system at 78. An example of such a transition is shown in FIG. 7.

It should be noted that the teachings described herein can apply to anyone of a number of analog input MFCs. For example, MFCs can employ many types of sensor arrangements including those that are pressure-based and those that are temperature-based.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A mass flow controller comprising:
an analog signal input configured to receive an analog set point signal;
a converter configured to convert the analog set point signal to a digital set point signal; and
a source of at least one exact non-changing digital set point signal precisely representing a desired rate of flow;
wherein the source provides the exact non-changing digital set point signal in response to the digital set point signal so long as the digital set point signal is within a preselected band defining a range of values.

2. A mass flow controller according to claim 1, wherein the source is configured to provide the exact non-changing digital set point signal in response to the digital set point signal within the preselected band for a predetermined amount of time.

3. A mass flow controller according to claim 2, wherein the level of the exact non-changing digital set point signal, the preselected band of the digital set point signal and the predetermined amount of time are user preselected.

4. A mass flow controller according to claim 1, wherein the source is configured to provide any one of a plurality of different exact non-changing digital set point signals, each exact non-changing digital set point signal being provided in response to a corresponding digital set point signal so long as the digital set point signal is within a respective preselected band defining a range of values associated with the that digital set point signal.

5. A mass flow controller according to claim 4, further including a sensor arrangement configured to provide data representing the actual rate of flow of gas through the mass flow controller, a control valve responsive to a valve control signal configured to control the flow of gas through the mass flow controller, and a control unit for generating a valve control signal as a function of a selected exact non-changing digital set point and the data representing actual rate of flow of gas through the mass flow controller.

6. A mass flow controller according to claim 5, where the sensor arrangement is thermal-based.

7. A mass flow controller according to claim 5, wherein the sensor arrangement is pressure-based.

8. A mass flow controller according to claim 5, wherein the valve control signal is a voltage predetermined as a function of the control valve and correlated to a valve position that provides a flow rate though the mass flow controller substantially equal to the selected set point.

9. A mass flow controller according to claim 1, further including a sensor arrangement configured to provide data representing the actual rate of flow of gas through the mass flow controller, and a control valve responsive to a valve control signal configured to control the flow of gas through the mass flow controller, wherein the source includes a processor configured to generate the valve control signal as a function of the exact non-changing digital set point and data representing the actual rate of flow of gas through the mass flow controller.

10. A mass flow controller according to claim 9, where the sensor arrangement is thermal-based.

11. A mass flow controller according to claim 9, wherein the sensor arrangement is pressure-based.

12. A mass flow controller according to claim 9, wherein the valve control signal is a voltage predetermined as a function of the control valve and correlated to a valve position that provides a flow rate though the mass flow controller substantially equal to the set point.

13. A mass flow controller according to claim 1, wherein the source is configured to provide anyone of a plurality of different exact non-changing digital set point signals depending on the digital set point signal converted by the converter.

14. A mass flow controller according to claim 1, further including enabling/disabling arrangement configured to the allow the mass flow controller to operate in at least two modes of operation, the first mode of operation wherein the mass flow rate is a function of the exact non-changing digital set point signal, and a second mode of operation wherein the mass flow rate is a function of the digital set point signal converted by the converter.

15. A method of providing at least one predetermined fixed valve control signal representing a desired flow rate through a control valve of a mass flow controller, in response to an analog set point signal, independent of noise in the analog set point signal, the method comprising:
receiving the analog set point signal at an analog signal input;
converting the analog set point signal to a digital set point signal; and
providing the exact non-changing digital set point signal in response to the digital set point signal so long as the digital set point signal is within a preselected band defining a range of values.
